(19) United States
(12) Patent Application Publication
(10) Pub. No.: US 2014/0360129 A1
(43) Pub. Date: Dec. 11, 2014

(54) DEVICE FOR INTRODUCING A FORCE INTO TENSION MEMBERS MADE OF FIBER-REINFORCED FLAT-STRIP PLASTIC LAMELLAS

(71) Applicant: SIKA TECHNOLOGY AG, Baar (CH)

(72) Inventor: Thierry BERSET, Winterthur (CH)

(73) Assignee: SIKA TECHNOLOGY AG, Baar (CH)

(21) Appl. No.: 14/465,223

(22) Filed: Aug. 21, 2014

Related U.S. Application Data
(63) Continuation of application No. PCT/EP2013/053358, filed on Feb. 20, 2013.

(30) Foreign Application Priority Data
Feb. 21, 2012 (EP) 12156397.7

(51) Int. Cl. E04C 5/12; F16B 2/14

(52) U.S. Cl. CPC E04C 5/127; F16B 2/14
USPC 52/745.19; 24/564

(57) ABSTRACT

The disclosure relates to a device for introducing a force into tension members made of fiber-reinforced flat-strip plastic lamellas, including at least one clamping element arranged on the tension member and having at least one surface in contact with the tension member. At least one sleeve is arranged around the clamping element and the tension member and exerts a clamping pressure onto the tension member via the clamping element. The clamping element is made of at least two layers which lie one on top of the other; a first soft layer of a material and at least one second hard layer.

### RELATED APPLICATION(S)

This application claims priority as a continuation application under 35 U.S.C. §120 to PCT/EP2013/053358, which was filed as an International Application on Feb. 20, 2013 designating the U.S., and which claims priority to European Application 12156397.7 filed in Europe on Feb. 21, 2012. The entire contents of these applications are hereby incorporated by reference in their entireties.

### FIELD

The disclosure relates to a device for introducing a force into tension members made of fiber-reinforced flat-strip plastic lamellas, to a method for introducing a force into such tension members, to the use of such a device, to tension members that include one or more devices according to the disclosure, and to a method for reinforcing bearing structures using the device according to the disclosure.

### BACKGROUND INFORMATION

The reinforcing of bearing structures, for example, during the refurbishing of existing buildings, by applying tension members made of fiber-reinforced flat-strip plastic lamellas, which can be made to adhere under tension to the bearing structure, is known and can have numerous advantages in comparison to the reinforcing of bearing structures by steel constructions. Because the introduction of a force into the tension members occurs primarily via their final anchoring on the tension sides of the bearing structure, reinforcing is considered to be particularly important. For the final anchoring but also for the pre-tensioning of tension members made of fiber-reinforced flat-strip plastic lamellas, different systems are known which can take into consideration the issues associated with handling fiber-reinforced flat-strip lamellas. Systems including wedges and sleeves are known, in which the wedges can be applied around the tension member and subsequently driven in the tension direction of the fiber-reinforced flat-strip plastic lamellas into a high-strength sleeve. Because the cross section reduction of the wedges is formed in the tension direction, the wedges under tensile loading can be pulled out of the sleeve.

For example, WO 2005/061813 A1 describes anchorings for tension members including two wedges and an anchoring body which substantially represents a sleeve for the wedges. Between wedges and tension members and/or between wedges and sleeve, a second, again wedge-shaped layer can be arranged. This second wedge-shaped layer can be made of a material having a lower modulus of elasticity than that of the first wedge. The introduction of a force into the tension member occurs in the described system by the sleeve; i.e., by bracing of the sleeve on the bearing structure to be reinforced. The devices described in WO 2005/061813 A1 can involve, at the time of the application of the device for introducing a force into the tension member, the wedges with tension member being driven into the sleeve. Because the wedges should be driven in the tension direction of the tension member, tensioning force on pre-tensioned tension members can be lost in the use of such systems.

### SUMMARY

A device is disclosed for introducing a force into a tension member made of fiber-reinforced flat-strip plastic lamellas, the device comprising at least one clamping element configured for arrangement on a tension member and having at least one surface for contact with the tension member; and at least one sleeve arranged around the clamping element, and configured to be arranged around the tension member, for exerting a clamping pressure on the tension member via the clamping element; wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer; and the clamping elements as a whole have a structure without wedge taper, or have a wedge-shaped or conical structure having a cross section reduction running against a tension direction of the tension member into which a force is to be introduced; and the sleeve has an interior shape configured for receiving the at least one clamping element and for exerting a clamping pressure.

A tension member is disclosed made of fiber-reinforced flat-strip plastic lamellas, including at least one device for introducing a force into a tension member, the device comprising: at least one clamping element configured for arrangement on a tension member and having at least one surface for contact with the tension member; and at least one sleeve arranged around the clamping element, and configured to be arranged around the tension member, for exerting a clamping pressure on the tension member via the clamping element; wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer; the clamping elements as a whole have a structure without wedge taper, or have a wedge-shaped or conical structure having a cross section reduction running against a tension direction of the tension member into which a force is to be introduced; and the sleeve has an interior shape configured for receiving the at least one clamping element and for exerting a clamping pressure.

A method for introducing a force into a tension member made of fiber-reinforced flat-strip plastic lamellas is disclosed, the method comprising: i) arranging a device including at least one clamping element on the tension member with at least one surface in contact with the tension member; and thereafter sliding or pulling at least one sleeve around the clamping element and the tension member for exerting a clamping pressure on the tension member via the clamping element; wherein the clamping element is made of at least two layers arranged one on top of the other including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member, and the sleeve has an interior shape configured for receiving the at least one clamping element and for exerting a clamping pressure to the tension member; ii) applying a tensioning device to the at least one clamping element with the sleeve, which is arranged on the tension member; iii) introducing force into the tension member by the tensioning device.

A method for introducing a force into a tension member made of fiber-reinforced flat-strip plastic lamellas is disclosed, the method comprising: i) providing the tension member which is anchored with one end on a bearing structure; ii) applying a tensioning device to a non-anchored end of the tension member; iii) tensioning the tension member by the tensioning device; iv) arranging a device including at least one clamping element on the tension member with at least one surface in contact with the tension member; and thereafter sliding or pulling at least one sleeve around the clamping element and the tension member for exerting a clamping pressure on the tension member via the clamping element; wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member, and the sleeve has an interior shape configured for receiving the at least one clamping element and for exerting a clamping pressure to the non-anchored end of the tension member, and v) anchoring the non-anchored end of the tension member.

A method for reinforcing bearing structures is disclosed, comprising: i) providing a tension member made of fiber-reinforced flat-strip plastic lamellas, each member having a device including at least one clamping element arranged on the tension member and having at least one surface in contact with the tension member; and arranging at least one sleeve around the clamping element, and the tension member for exerting a clamping pressure on the tension member via the clamping element, wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member, and wherein the sleeve has an interior shape configured for receiving the at least one clamping element and for exerting a clamping pressure as closing elements; ii) attaching a two-part tensioning device including anchoring and tensioning element in marginal areas of a site of a bearing structure which is to be reinforced; iii) arranging the tension member on the surface of the bearing structure and introducing a closing element into a component of the tensioning device; iv) tensioning the tension member; and v) adhering the tensioned tension member to the bearing structure.

A method for reinforcing bearing structures is disclosed, comprising: i) providing a tension member made of fiber-reinforced flat-strip plastic lamellas, which has at one end a device for introducing a force into the tension member made of fiber-reinforced flat-strip plastic lamellas as a closing element; ii) attaching in each case one anchoring in marginal areas of a site of the bearing structure, which is to be reinforced, and applying the tension member with the closing element to one of the anchorings; iii) applying a tensioning device to an end of the tension member which has no closing element; iv) tensioning the tension member by the tensioning device and arranging the tension member on the anchoring not yet occupied; v) arranging a device to the non-anchored end of the tension member, the device including at least one clamping element on the tension member and having at least one surface in contact with the tension member, and sliding or pulling at least one sleeve around the clamping element and the tension member and for exerting a clamping pressure on the tension member via the clamping element, wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member; and wherein the sleeve has an interior shape configured for receiving the at least one clamping element and for exerting a clamping pressure; and vi) adhering the tensioned tension member adhere to the bearing structure.

### BRIEF DESCRIPTION OF THE DRAWINGS

Exemplary embodiments of the disclosure can be explained in further detail based on the drawings. Identical elements in the different figures can be provided with identical reference numerals. The disclosure is not limited to the exemplary embodiments shown and described in the drawings, wherein:

FIG. 1 diagrammatically shows a device according to an exemplary embodiment of the disclosure with a tension member;

FIG. 2 diagrammatically shows a device according to an exemplary embodiment of the disclosure with a tension member;

FIG. 3 diagrammatically shows a cross section through a device according to an exemplary embodiment of the disclosure with a tension member;

FIG. 4 diagrammatically shows a cross section through a device according to an exemplary embodiment of the disclosure with a tension member;

FIG. 5 diagrammatically shows a cross section through a device according to an exemplary embodiment of the disclosure with a tension member;

FIG. 6a diagrammatically shows a longitudinal section through a device according to an exemplary embodiment of the disclosure with a tension member;

FIG. 6b diagrammatically shows a longitudinal section through a device according to an exemplary embodiment of the disclosure with a tension member and a multi-part sleeve;

FIG. 7 diagrammatically shows a section of the structure of a device according to an exemplary embodiment of the disclosure with a friction element and a tension member;

FIG. 8 diagrammatically shows a longitudinal section through a device according to an exemplary embodiment of the disclosure with a slotted plate and a tension member;

FIGS. 9a to 9d diagrammatically show a longitudinal section through a device according to an exemplary embodiment of the disclosure, respectively, wherein clamping elements with soft and hard layers can be represented;

FIGS. 10a to 10e diagrammatically show a method of an exemplary embodiment of the disclosure for introducing a force into tension members made of fiber-reinforced flat-strip plastic lamellas, in a longitudinal section;

FIGS. 11a and 11b diagrammatically show an anchoring of a tension member with a device according to an exemplary embodiment of the disclosure for introducing a force, on a bearing structure to be reinforced, in a longitudinal section and in a top view;

FIGS. 12a and 12b diagrammatically show a tensioning element for a tension member with a device according to an exemplary embodiment of the disclosure for introducing a force, on a bearing structure to be reinforced, in a longitudinal section and in a top view.

In the figures, only the elements essential for the understanding of the embodiments disclosure are shown.

### DETAILED DESCRIPTION

Exemplary embodiments of the present disclosure can provide a device for introducing a force into tension members made of fiber-reinforced flat-strip plastic lamellas, which can overcome disadvantages of existing devices and which can be applied to a tensioned tension member without tensioning force being lost in the process.

Exemplary embodiments of the disclosure provide a device for introducing a force into tension members made of fiber-reinforced flat-strip plastic lamellas, including at least one clamping element which is arranged on the tension member and which has at least one surface in contact with the tension member, as well as at least one sleeve which can be arranged around the clamping element and the tension member and thus exerts a clamping pressure on the tension member via the clamping element. The clamping element can be made of at least two layers which lie one on top of the other. At least one first soft layer can be made of a material that has a modulus of elasticity ranging from, for example, 1000 to 6000 MPa. At least one second hard layer can be made of a material that has a higher modulus of elasticity than the soft layer. The clamping elements as a whole can have a structure without a wedge taper or have a wedge-shaped or conical structure. The cross section reduction runs against the tension direction of the tension member in this case, and the sleeve has an interior shape which is suitable for receiving the at least one clamping element and for exerting a clamping pressure.

It has been found that devices according to exemplary embodiments of the disclosure can produce an unexpected result whereby an efficient introduction of a force into tension members made of fiber-reinforced flat-strip plastic lamellas can be possible, in which, even during use on a pre-tensioned or tensioned tension member, no tensioning force may be lost due to the way of driving the clamping elements into the sleeve.

Moreover, devices according to exemplary embodiments of the disclosure can have the exemplary advantage that the use of clamping elements having the described properties can generate a uniform clamping pressure or transverse pressure in the boundary surface between tension member and clamping element, which can allow a highly efficient and uniform introduction of a force into tension members.

Devices according to exemplary embodiments of the disclosure can include a reduction of the long-term deformation of the clamping elements and thus a reduction of the loss of tensioning force due to creep of the material.

In an exemplary use of devices according to exemplary embodiments of the disclosure with corresponding tension members made of carbon fiber-reinforced flat-strip lamellas for reinforcing a bearing structure, the plastic which can be used at least for the soft layer of the clamping elements, can ensure in addition the galvanic separation between the electrically conductive lamella and the anchoring, which can be made of steel, in the building. Without galvanic separation, there is a risk of the tension member becoming electrically connected via the anchorings to the inner steel reinforcement of the reinforced concrete construction element to be reinforced, forming with the latter a galvanic macroelement. This can lead to a very rapidly progressing corrosion of the anchorings or of the inner steel reinforcement of the reinforced concrete construction element.

FIG. 1 shows an exemplary device 1 for introducing a force into tension members 2 made of fiber-reinforced flat-strip plastic lamellas, including a clamping element 3 which can be arranged on the tension member and has a surface in contact with the tension member, as well as at least one sleeve 4 which can be arranged around the clamping element and the tension member and thus exerts a clamping pressure on the tension member via the clamping element.

The clamping element here can be made of at least two layers one on top of the other including at least a first soft layer which can be made of a material that has a modulus of elasticity ranging from, for example, 1000 to 6000 MPa, and at least a second hard layer which can be made of a material that has a higher modulus of elasticity than the soft layer.

Thus, in the disclosure, the term “soft layer” can describe the layer of the clamping element which has a modulus of elasticity ranging from, for example, 1000 to 6000 MPa. The layer of the clamping element having a higher modulus of elasticity than that of the soft layer can be referred to as “hard layer.”

Moreover, it can be desirable for exemplary embodiments of the present disclosure that the clamping elements as a whole have a structure without wedge taper or have a wedge-shaped or conical structure, wherein, in this case, the cross section reduction runs against the tension direction of the tension member, and the sleeve has an interior shape which is suitable for receiving the at least one clamping element and for exerting a clamping pressure.

The expression “the clamping elements as a whole” here is understood to refer, for example, to all the clamping elements of a device. Thus, if a device includes two clamping elements, for example, then these two clamping elements also form the clamping elements as a whole. For the interpretation of the specification (e.g., requirement) that applies to the wedge taper, the clamping elements in the clamping elements as a whole of a device can be present in the same way as they can be arranged in the device. If the device has several clamping elements, this means that the clamping elements with their contact surfaces face one another, wherein at least the tension member can be arranged between the contact surfaces. Because the tension member may have no influence on the wedge taper of the clamping elements as a whole, it is also possible to take into consideration the clamping elements as a whole with mutually contacting surfaces, for estimating the wedge taper in the case of several clamping elements.

Within the mentioned requirement, the clamping element in principle can have any shape, provided it is suitable for clamping the tension member in between clamping element and sleeve or between several clamping elements.

For the sake of simplicity, in some figures the respective clamping elements can be represented as a single part (e.g., the hard layer and the soft layer are not represented separately).

For example, the device according to exemplary embodiments of the disclosure can have one or two clamping elements which can be arranged on or around the tension member and in each case have at least one surface in contact with the tension member.

In an exemplary embodiment of the disclosure with two clamping elements, the clamping elements can be each formed as one half of a cylinder halved in the longitudinal direction. In this case, the flat surface along which the cylinder has been halved represents the contact surface of the clamping element with the tension member. Moreover, the clamping elements as a whole can have a conical or a wedge-shaped structure, wherein the cross section reduction in this case runs against the tension direction of the tension member.

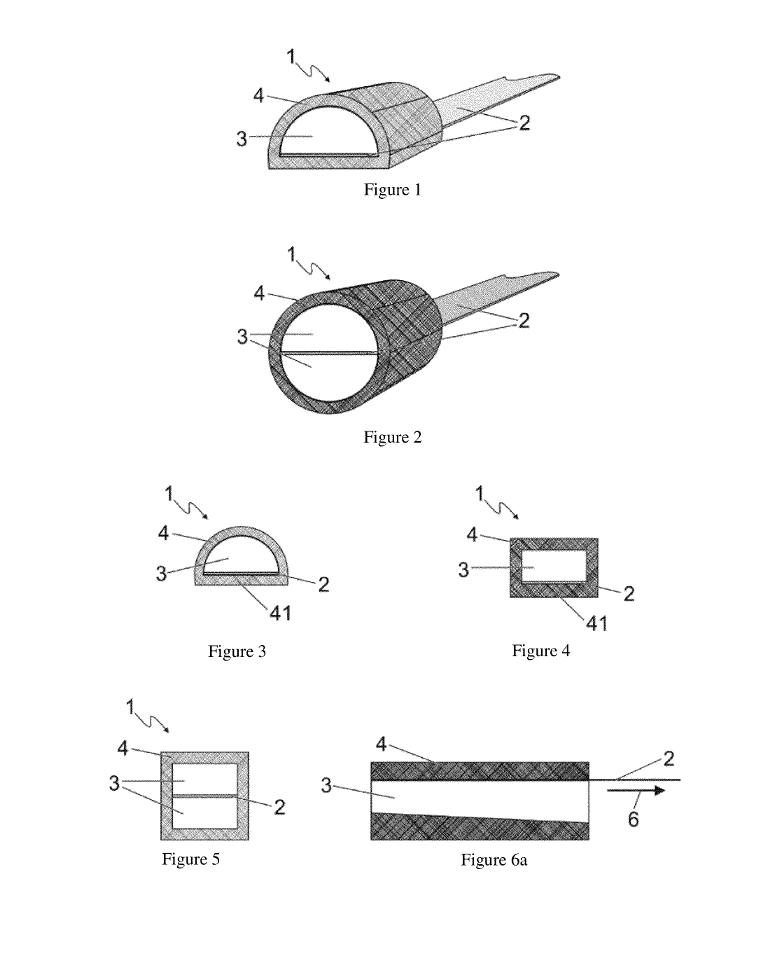

FIG. 2 shows an exemplary embodiment of the device 1 for introducing a force into tension members 2 made of fiber-reinforced flat-strip plastic lamellas, including two clamping elements 3 which can be arranged around the tension member and in each case have at least one surface in contact with the tension member, as well as at least one sleeve 4 which is arranged around the clamping elements and thus exerts a clamping pressure on the tension member via the clamping elements.

The sleeve is for example a rigid sleeve (e.g., the sleeve has a considerably higher stiffness relative to the clamping element and, for example, relative to the soft layer of the clamping element).

The sleeve can be made for example of a plastic, of metal, of a metal alloy or of another high-strength material. The sleeve can be made of, for example, fiber-reinforced plastic or steel, or carbon fiber-reinforced plastic based on epoxy resin.

In principle, the sleeve can be designed in any manner provided that it is suitable for receiving the clamping element(s) with tension member and optionally with friction element, and for exerting a sufficient clamping pressure on the tension member. Accordingly, the sleeve need not be designed in the shape of a tube. Instead, it can be a bore or recess suitable for receiving the clamping elements in an object having any desired shape. For example, FIG. 3 shows a cross section through a device 1 according to the disclosure including a tension member 2, of a clamping element 3 and of a sleeve 4, wherein the sleeve has the shape of a tube halved in longitudinal direction with a flat support 41 as counterpiece for the clamping element.

FIG. 4 shows a cross section through a device 1 according to an exemplary embodiment of the disclosure, wherein the sleeve 4 has a rectangular shape with a flat support 41 as counterpiece for the clamping element. In this embodiment, the clamping element 3 can have a cuboid shape or the shape of a blunt wedge. The cross section reduction of the blunt wedge runs against the tension direction of the tension member.

FIG. 5 shows a cross section through a device 1 according to an exemplary embodiment of the disclosure with a sleeve 4 which has a rectangular shape. This embodiment can include two clamping elements 3 which can be arranged around the tension member 2. Similarly to FIG. 4, the clamping elements 3 can have a cuboid shapes or the shape of blunt wedges. The cross section reduction of the blunt wedges runs against the tension direction of the tension member.

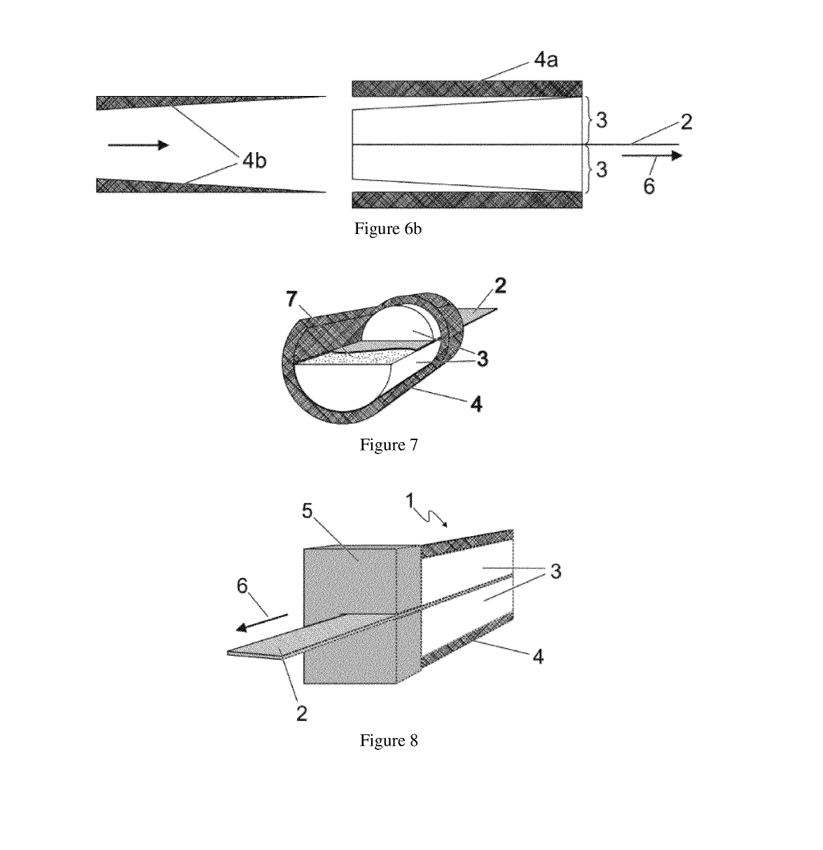

FIG. 6a shows a longitudinal section through a device according to an exemplary embodiment of the disclosure, including a tension member 2, of a clamping element 3 and a sleeve 4. The clamping element has a cross section reduction against the tension direction 6 of the tension member 2. The sleeve 4 correspondingly has an interior shape suitable for receiving the clamping elements and for exerting a clamping pressure.

Moreover, the sleeve can be designed to be a single-part or multi-part sleeve. In the multi-part design, it is also possible to use individual parts made of different materials. For example, the sleeve can be formed by an appropriate recess, for example, in the concrete of a bearing structure to be reinforced, in combination with a steel body covering the recess. In this case, the concrete surface would form the support, as shown in FIG. 4, for example.

An exemplary embodiment of a multi-part sleeve is also one in which the conicity of the sleeve can be generated by applying or sliding in a wedge or a wedge-shaped or conical body. This can occur, on the one hand, on the loose sleeve or also on the already mounted device in the case of a pre-tensioned tension member.

For example, FIG. 6b shows a longitudinal section through a device according to an exemplary embodiment of the disclosure, including a tension member 2, two clamping elements 3 (soft layer and hard layer not represented separately) and a sleeve 4 having a rectangular shape in cross section. In this case, the sleeve 4 has a multiple-part structure made of an external part 4a without cross section reduction or wedge taper and of two internal portions 4b which can be in the form of pointed wedges in this case. Thus, in a first step, the clamping elements can be applied on the pre-tensioned tension member 2. Subsequently, the external portion of the sleeve is slid over the clamping elements. Lastly, the internal portions of the sleeve can be driven in between the clamping elements and external portion of the sleeve, as a result of which transverse pressure is applied to the clamping elements. A similar embodiment is also particularly suitable in the case of a device with only one clamping element, as represented in FIG. 4, for example.

The sleeve can be a tubular sleeve with a round cross section, wherein the interior shape of the sleeve can be of a shape that is suitable for receiving the clamping elements with the tension member and optionally with the friction element, and that is suitable for exerting a sufficient clamping pressure on the tension member.

When two clamping elements in the form of blunt wedges can be used, a sleeve having a rectangular cross section can be used, wherein here too the interior shape of the sleeve can have a shape suitable for receiving the clamping elements with the tension member and optionally with the friction element. The sleeve here can be produced from sufficiently stiff plates.

In order to exert optimal clamping pressure on the tension member, the sleeve can have an interior shape which has a reduced cross section compared to the exterior shape of the clamping elements with the tension member and optionally with the friction element.

The difference between the diameter of the clamping elements as a whole with the tension member and optionally with the friction element, and the inner diameter of the sleeve can be, for example, 2 to 10%, preferably, for example, approximately 5%.

When providing the devices according to an exemplary embodiment of the disclosure, the sleeve is slid on the clamping element which is optionally provided with the friction element and arranged on the tension member, or the clamping element is driven into the sleeve, as a result of which the necessary clamping pressure on the tension member is built up.

If the device is one that has a multi-part sleeve, the clamping pressure can also be generated in other ways than by sliding on or driving in. For example, a multiple-part sleeve can be arranged and secured directly around the clamping elements. If the device is a device as represented in FIG. 6b, the clamping pressure is not generated by sliding on the sleeve as such but by driving in the inner portions, that is the wedges between the external portion of the sleeve and clamping elements.

The tension member includes a fiber-reinforced flat-strip plastic lamella which is known to the person skilled in the art for different applications. For example, it can involve unidirectionally fiber-reinforced flat-strip plastic lamellas. The fiber reinforcement can be carbon fibers. As a plastic matrix one can use, for example, an epoxy resin matrix. Suitable fiber-reinforced flat-strip plastic lamellas can be commercially available, for example, under the trade name Sika® CarboDur® from Sika Schweiz AG.

In an exemplary embodiment, devices according to the disclosure can include, in addition, a friction element, in the area of the contact surfaces between clamping element and tension member. The friction element can have the function of increasing the friction between clamping element and tension member and thus of preventing the tension member from slipping out of the device, even in the case of particularly high tensioning forces.

For example, the friction element can be selected from a coating of the tension member with hard grains, a coating of the clamping elements with hard grains and a fabric, for example a web or a mesh, occupied by hard grains.

The hard grains can be, for example, sharp-edged grains which can be made of a material that has a Mohs hardness in the range of, for example, >5, for example of >7, preferably of >9. For example, the hard grains can be made of corundum or silicon carbide.

The grain size of the hard grains can be from, for example, 0.05 to 1.0 mm, and more particularly, for example, from 0.2 to 0.5 mm.

The friction element can be made of a coating of hard grains on the clamping element in the area of its surface in contact with the tension member.

If the device is an embodiment with more than one clamping element, the device can include, in addition, in each case a friction element, for example in the area of the contact surfaces between all clamping elements and tension member.

FIG. 7 shows a diagrammatic layer structure of a device as already described in FIG. 2, wherein the clamping elements 3 in this embodiment include a friction element 7 in the form of a coating of the clamping elements with hard grains.

The introduction of a force into the tension member can occur via the clamping element or the clamping elements of the device and not via the sleeve.

As represented in FIG. 8, the introduction of a force can occur in that, viewed in the tension direction 6 of the tension member 2, before the device 1 according to an exemplary embodiment of the disclosure, a slotted plate 5 is arranged, on which the clamping element or the clamping elements 3 is/are braced. The slotted plate here has a slot through which the tension member can be led. At the same time, the slotted plate braces the clamping elements 3 on as large a surface as possible.

Because, as can be seen in FIG. 8, the sleeve 4 is also braced at least partially on the slotted plate 5, it will be clear to those skilled in the art that a certain amount of force transmission to the tension member can occur via the sleeve, but that the introduction of a force occurs primarily via the clamping elements 3.

The slotted plate can be made, for example, of metal or of a metal alloy. Moreover, the slotted plate does not have to be designed in the form of a single part. Instead it can be made from several parts. A single-part slotted plate is suitable, for example, if it is to be applied on a tension member that is already ready to be used and already provided with devices according to an exemplary embodiment of the disclosure for introducing a force.

The introduction of a force into the tension member via the clamping element or the clamping elements of the device according to exemplary embodiments of the disclosure can be particularly advantageous. In this embodiment, the clamping elements can be enclosed between sleeve, tension member and bracing, and, in the case of large loads, they can undergo a constant-volume elastic and viscoplastic deformation in the region of the contact surface of the clamping element and of the traction element, deformation which is due to the special structure of the clamping elements, which includes of at least two layers one on top of the other, and which leads to the equalization of tensions between clamping element and tension member. This property can improve the clamping effect of the clamping elements and thus the efficiency of the introduction of a force.

In an exemplary embodiment, devices according to the disclosure, as described above, can include two clamping elements which can be arranged around the tension member and in each case have a surface in contact with the tension member. Each of the contact surfaces can be provided, for example, with a friction element, as well as a sleeve made of carbon fiber-reinforced plastic, which is arranged around the two clamping elements and thus exerts a clamping pressure on the tension member via the clamping elements.

According to exemplary embodiments of the disclosure, the clamping element can be formed by at least two layers one on top of the other. At least one first soft layer which can be made of a material that has a modulus of elasticity ranging from, for example, 1000 to 6000 MPa, and at least one second hard layer of which can be made of a material that has a higher modulus of elasticity than the soft layer.

A clamping element of the device according to an exemplary embodiment of the disclosure can be made of two layers. The first soft layer can be arranged between the tension member 2 and the second hard layer, or the first soft layer can be arranged between the second layer and the sleeve 4.

In an exemplary embodiment, a clamping element of a device according to the disclosure can include three layers, wherein in each case one soft layer adjoins the tension member 2 and one adjoins the sleeve 4, and a hard layer is arranged between the two soft layers.

A clamping element 3 of a device according to an exemplary embodiment of the disclosure can include at least one soft layer adjoining the tension member 2, wherein this soft layer has a wedge-shaped structure with a cross section reduction running against the tension direction of the tension member. This embodiment, in which the greatest thickness of the soft layer is located in the area near the load can uniformly distribute, or even slightly increase, the contact pressure and the shear stress between clamping element and tension member, from the area near the load to the area far from the load.

It can be desirable for the mean section height of the hard layer of a clamping element of a device according to an exemplary embodiment of the disclosure to be greater than the mean section height of the soft layer.

In the clamping elements of a device according to an exemplary embodiment of the disclosure, the material of the at least one soft layer can have a modulus of elasticity ranging from, for example, 1000 to 6000 MPa. For example, the material of the soft layer can have a bending tensile strength of ≧25 MPa, particularly of, for example, 50 to 150 MPa, and an exemplary compressive strength of ≧25 MPa.

The indicated values relate to measurements corresponding to the standards ISO 604 for the modulus of elasticity and ISO 178 for the bending tensile strength and the compressive strength.

The material of the soft layer of the clamping element can be, for example, plastic. Here it is possible to use, in principle, any desired plastic having the appropriate physical properties, wherein the plastic can be filled or unfilled or optionally fiber reinforced. As filled plastic one can use an elasticized mortar, for example.

For example, the soft layer of the clamping element can be made of a plastic including at least one polyurethane polymer. The plastic can be unfilled.

Exemplary advantages of the plastic that is used can be the high bending tensile strength and compressive strength relative to the modulus of elasticity, the highly satisfactory dimensional stability, the very high resistance to swelling as well as the dense slippery surface. The low sliding friction allows the buildup of large clamping forces with relatively low pressing force.

The layer of the clamping element which can be soft in comparison to the tension member, to the sleeve as well as to the hard layer of the clamping element can generate a uniform clamping pressure on the tension member, which allows a very efficient and uniform introduction of a force into the tension member. In the case of tension members made of unidirectionally fiber-reinforced flat-strip plastic lamellas for example, this is desirably, because different tensions between the fibers can be compensated for only to a limited extent.

A suitable exemplary plastic for manufacturing a soft layer of the clamping element is commercially available under the trade names SikaBlock®, preferably SikaBlock® M940, from Sika Deutschland AG.

The material of the hard layer of the clamping element can be, for example, a material having a modulus of elasticity of >6000 MPa, a modulus of elasticity ranging from 10,000 to 220,000 MPa, ranging from 12,000 to 25,000 MPa. For example, as material that is suitable for the hard layer of the clamping element, it is possible to use steel having a modulus of elasticity of approximately 210,000 MPa or a plastic, such as polyurethane or epoxy resin, which can be filled or unfilled, and which can have two or three times higher moduli of elasticity than the material of the soft layer. For the manufacture of the hard layer of the clamping element, it is also possible, in principle, to use the same plastic matrix as for the soft layer. In the case of the hard layer, the modulus of elasticity can be adjusted, for example, by fillers and degree of filling.

The soft layer and the hard layer of the devices according to an exemplary embodiment of the disclosure can be placed loosely one on top of the other, so that they can be held against one another only via the clamping pressure within the device, or they can also be connected to one another. For example, the clamping element can be formed as a composite construction element made of the two layers.

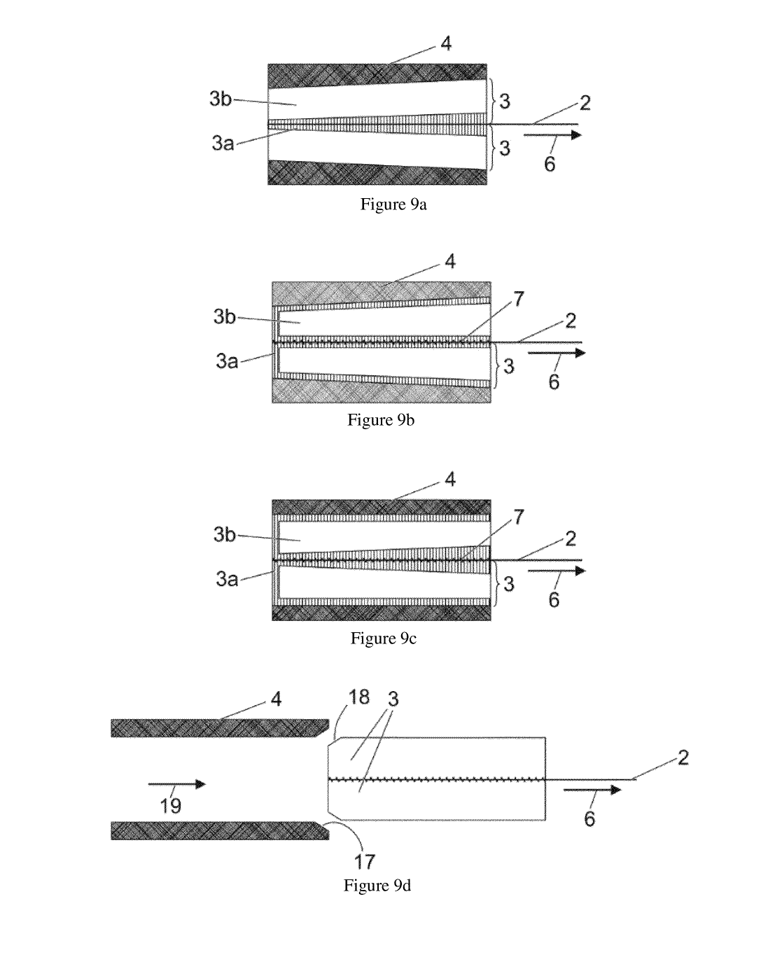

FIG. 9a shows a device according to an exemplary embodiment of the disclosure in which the clamping elements 3 as a whole have a conical structure. The cross section reduction runs against the tension direction 6 of the tension member 2. The sleeve 4 has an interior shape suitable for receiving the clamping elements and for exerting a clamping pressure, that is to say also a conical recess. The clamping elements 3 in each case can be formed by two layers one on top of the other. The first soft layer 3a can be made from a material that has a modulus of elasticity ranging from 1000 to 6000 MPa, can be applied directly on the tension member 2. The second hard layer 3b can be made from a material that has a higher modulus of elasticity than the soft layer, can be located between the soft layer 3a and the sleeve 4. The soft layer 3a can be configured in the shape of a wedge or as a blunt wedge. The cross sectional area reduction of the wedge runs against the tension direction 6 of the tension member 2.

FIG. 9b shows a device according to an exemplary embodiment of the disclosure in which the two clamping elements 3 each have a conical structure with cross section reduction against the tension direction 6 of the tension member 2, and a corresponding sleeve 4 with conical recess. The clamping elements 3 in each case can be formed by a soft layer 3a and a hard layer 3b, wherein the soft layer 3a encloses the hard layer 3b on three sides. Moreover, the device of FIG. 9b has a friction element 7 between the tension member 2 and the clamping element 3.

FIG. 9c shows a device according to an exemplary embodiment of the disclosure in which the two clamping elements 3 each have a cylindrical structure without wedge taper and a corresponding sleeve 4 with cylindrical recess. The clamping elements 3 can be formed by a soft layer 3a and a hard layer 3b. The soft layer 3a can enclose the hard layer 3b on three sides. The soft layer 3a between tension member 2 and hard layer 3b can be configured in the shape of a wedge or as a blunt wedge. The cross sectional area reduction of the wedge runs against the tension direction 6 of the tension member 2. Moreover, the device of FIG. 9c has a friction element 7 between the tension member 2 and the clamping element 3.

In a manner similar to the embodiments shown in FIGS. 9a, 9b and 9c, these embodiments can be suitable in the case of devices with one clamping element or more than two clamping elements.

In all three embodiments shown in FIGS. 9a, 9b and 9c, the diameter of the clamping elements 3 as a whole can be greater than the inner diameter of the sleeve. As a result, an optimal clamping pressure can be exerted on the tension member 2.

The embodiment shown in FIG. 9c can be easy to manufacture. For example, in this embodiment, the manufacture of the sleeve is particularly simple, because it can be achieved by cutting up, for example, a tube made of appropriate material. In the embodiments shown in FIGS. 9a and 9b, the outer side of the clamping elements as a whole and the interior shape of the sleeve have an exemplary wedge taper ranging from 1:4 to 1:200, for example in the range of 1:100. The embodiments with wedge taper in comparison to the embodiments without wedge taper, can have the advantage that it is easier to slide or pull the sleeve over the clamping elements with tension member and optionally with friction element, or to drive the clamping elements into the sleeve.

In order to allow a facilitated sliding or pulling of the sleeve onto the clamp elements, the sleeve can have, on the side from which it is slid or pulled onto the clamping elements, an additional recess suitable for that purpose on its inner side. A suitable recess here can be, for example, a chamfer.

For the same reason, the clamping element or the clamping elements can also have such a recess on the side from which they can be driven into the sleeve or from which the sleeve is slid or pulled over the clamping elements. For example, this recess too can be configured as a chamfer.

FIG. 9d shows an exemplary embodiment of a device according to the disclosure before the sleeve 4 has been slid in the sliding-on direction 19 over the clamping elements 3, wherein the sleeve 4 is provided with a chamfer 17, which allows the facilitated driving in of the clamping elements. Moreover, the clamping elements as well can be provided with a chamfer 18, for the same purpose.

Moreover, the present disclosure relates to the use of a device as described above for introducing a force into tension members made of fiber-reinforced flat-strip plastic lamellas.

Devices according to exemplary embodiments of the disclosure can here be applied at any site of the flat-strip plastic lamella, depending on where the introduction of a force is to take place. For example, the device forms the closing element of the tension member.

Moreover, devices according to exemplary embodiments of the disclosure can also be used for the purpose of connecting several tension members made of flat-strip plastic lamellas to one another. For this purpose, the tension members can be arranged with mutual overlap at least over the total length of the device. Then, a device according to an exemplary embodiment of the disclosure can be applied on the site of the overlap. For example, in the case of such a use, a friction element according to the previous description is inserted between the tension members to be connected.

Moreover, the present disclosure relates to a tension member made of fiber-reinforced flat-strip plastic lamellas, including at least one device as described above.

For example, the tension member is one that has a closing element on at least one and, for example on both ends, wherein this closing element is a device according to the above description.

The present disclosure also relates to a tension member arrangement including two or more tension members which can be connected to one another by a device according to the disclosure.

Moreover, the disclosure relates to a method for introducing a force into tension members made of fiber-reinforced flat-strip plastic lamellas, including the steps i) applying a device according to an exemplary embodiment of the disclosure to a tension member 2, wherein first at least one clamping element 3 can be arranged on the tension member and thereafter a sleeve 4 can be slid or pulled over the at least one clamping element and the tension member, so that a clamping pressure can be exerted on the tension member; ii) applying a tensioning device to the at least one clamping element with sleeve, which is arranged on the tension member; iii) introducing the force into the tension member by the tensioning device.

An additional method for introducing a force into tension members made of fiber-reinforced flat-strip plastic lamellas, which is also the subject matter of the disclosure can include the steps: i) providing a tension member 2 which is anchored with one end on a bearing structure; ii) applying a tensioning device to the non-anchored end of the tension member; iii) tensioning the tension member by the tensioning device; iv) applying a device according to an exemplary embodiment of the disclosure to the non-anchored end of the tension member 2, wherein first at least one clamping element 3 is arranged on the tension member and thereafter a sleeve 4 is slid or pulled over the at least one clamping element and the tension member, so that a clamping pressure is exerted on the tension member; v) anchoring the non-anchored end of the tension member.

Embodiments of a device according to the disclosure with two clamping elements can be particularly suitable for the two above-described methods.

Moreover, in the described methods, a tensioning device can be applied on only one end of the tension member. At the other end of the tension member, the tension member is anchored, for example, also by using a device according to an exemplary embodiment of the disclosure as closing element.

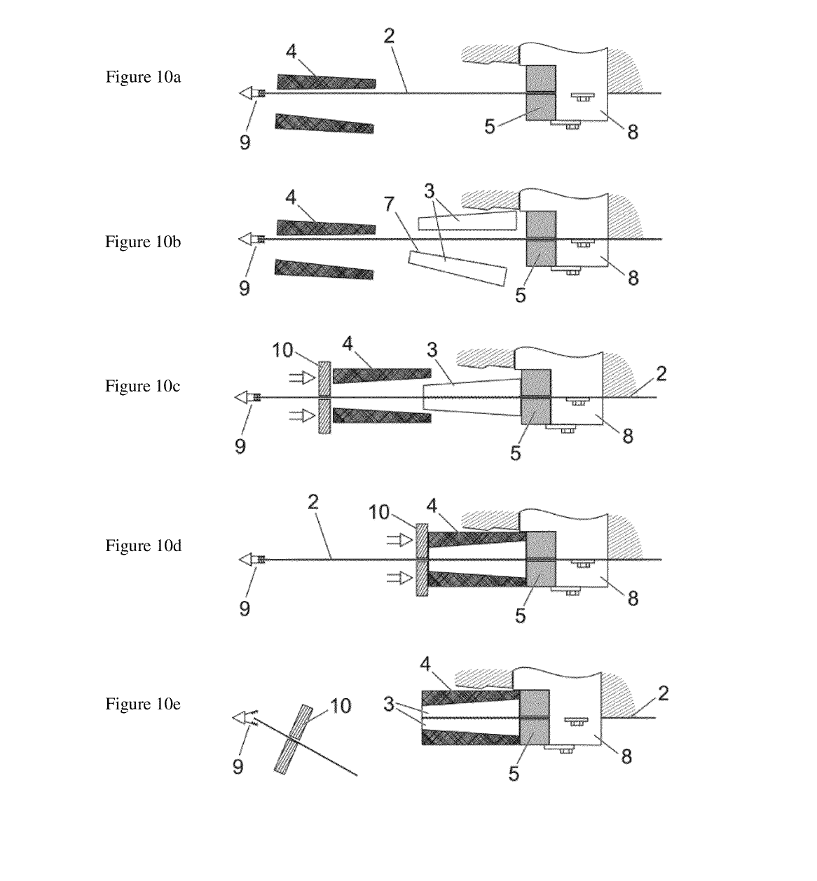

In FIGS. 10a to 10e, an exemplary method according to the disclosure for introducing a force into tension members made of fiber-reinforced flat-strip plastic lamellas is represented diagrammatically. Here, an embodiment of the device according to an exemplary embodiment of the disclosure with two clamping elements is represented. For the sake of simplicity, the clamping elements can be in each case represented as single-part elements; i.e., the hard layer and the soft layer are not represented separately. Methods using devices with one clamping element or more than two clamping elements proceed in a similar way.

FIG. 10a shows a tension member 2 which is anchored on one side and which has been tensioned and is kept in the tensioned state by tensioning device 9 which also shows the tension direction of the tension member with an arrow tip. The clamping tension direction of the tension member runs in the opposite direction relative to the tension direction of the tension member. Moreover, FIG. 10a shows a holding device 8 which keeps the tension number in the desired position and which is used as an attachment for the slotted plate 5, as well as the sleeve 4 through which the tension member 2 has been led.

In addition to FIG. 10a, FIG. 10b shows two clamping elements 3, which can be provided with a friction element 7 and which can be in the process of being arranged around the tension member 2.

FIG. 10c moreover shows the clamping elements 3 brought into their final position and the sleeve 4 which is slid over the clamping elements. Here, the sleeve can be slid by any suitable device over the clamping elements. For example, this is occurs by a second slotted plate 10.

FIG. 10d shows the device 1 according to an exemplary embodiment of the disclosure, as it is arranged in the completed state on the tension member. In this state, the second slotted plate 10 as well as the tensioning device 9 can be removed. The excess of the tension member between the device according to the disclosure and the tensioning device can be removed. This is shown in FIG. 10e.

A method for connecting two or more tension members, wherein the tension members can be connected to one another by a device according to an exemplary embodiment of the disclosure as described above includes for example the steps i) providing two or more tension members that can be arranged with mutual overlap; ii) applying at least one clamping element at a site where several tension members overlap, so that the clamping element has at least one surface in contact with one of the tension members located on the outside; iii) sliding or pulling a sleeve over the at least one clamping element and the tension members, so that a clamping pressure is exerted on the tension members.

In the described method for connecting two or more tension members, the tension members can be for example tensioned or pre-tensioned. Moreover, it is possible to insert in each case a friction element as described above between the tension members.

Devices according to exemplary embodiments of the disclosure in connection with tension members made of fiber-reinforced flat-strip plastic lamellas can be particularly suitable for reinforcing bearing structures, for example bearing structures made of concrete.

Such systems can be used for refurbishing existing bearing structures such as bridges or ceilings, for example. Moreover, systems described can also be used for reinforcing brick walls, wooden bearing structures, steel constructions, earthquake reinforcements and the like.

The attachment of the above-described tension members according to the disclosure to the bearing structure can occur via anchorings which can be already known to those skilled in the art.

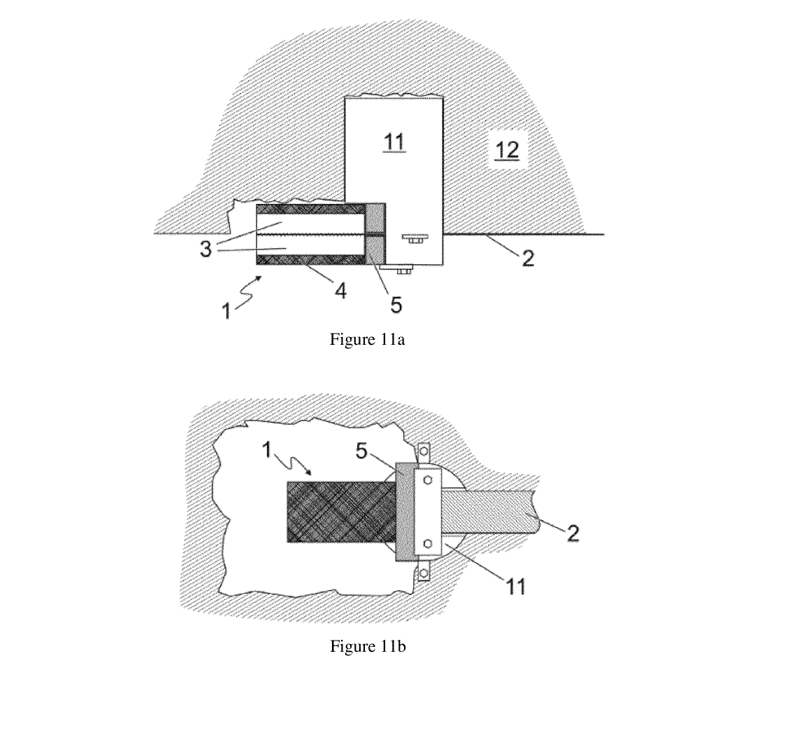

FIGS. 11a and 11b show, for example, the anchoring of a tension member 2, provided with a device 1 according to an exemplary embodiment of the disclosure for introducing a force, on a bearing structure 12 to be reinforced. Here, an embodiment of the device with two clamping elements is represented. For the sake of simplicity, the clamping elements can be represented each as a single-part element; i.e., the hard layer and the soft layer are not represented separately.

Here, an anchoring 11, which keeps the tension member 2 in an exemplary desired position and functions as an attachment for the slotted plate 5, is applied to the support structure 12. The device 1 for introducing a force, which represents the closing element of the tension member 2, viewed in the tension direction of the tension member, can be located behind the anchoring 11 or behind the slotted plate 5. The introduction of a force into the tension member here occurs via the clamping elements 3, by bracing of the latter on the slotted plate 5.

Moreover, the attachment of the tension member can have a tensioning element 13 which allows the tensioning of the tension member.

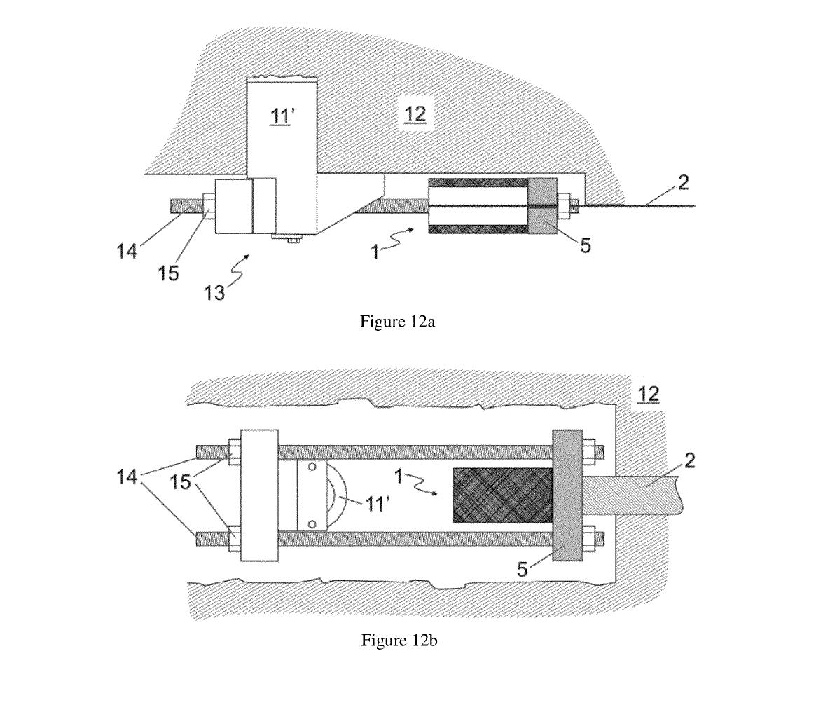

FIGS. 12a and 12b show, for example, a suitable tensioning element for tensioning a tension member, which is provided with a device 1 according to an exemplary embodiment of the disclosure for introducing a force, on a bearing structure 12 to be reinforced.

In contrast to the anchoring described in FIGS. 11a and 11b, in the case of the tensioning element, the slotted plate 5 is not located directly on the anchor 11′ of the tensioning element, but can be connected to the anchor via two threaded rods 14. The tensioning of the tension member occurs by tightening the screw nuts 15. The introduction of a force into the tension member here too occurs via the clamping elements 3, by bracing of the latter on the slotted plate 5.

Accordingly, the exemplary embodiments of the disclosure can also relate to methods for reinforcing bearing structures 12, including the steps i) providing a tension member 2, each member having a device 1 according to the previous description as closing element; ii) attaching a two-part tensioning device including the anchoring 11 and the tensioning element 13 in the marginal areas of the site of the bearing structure 12 which is to be reinforced; iii) arranging the tension member 2 on the surface of the bearing structure 12 and introducing the closing elements each into one component of the tensioning device; iv) tensioning the tension member 2; v) making the tensioned tension member adhere to the bearing structure 12.

If the bearing structure reinforcement is carried out by a method as represented in FIGS. 10a to 10e, anchorings as described above and represented in FIGS. 11a and 11b can be used for the purpose of anchoring the tension member. The use of a tensioning element in this case is not necessary, which represents an advantage of this embodiment particularly for reasons pertaining to costs. The tensioning device used for tensioning the tension member can be removed again after the tensioning and securing.

Accordingly, the exemplary embodiments of the disclosure also relate to a method for reinforcing bearing structures 12, including the steps i) providing a tension member 2 made of fiber-reinforced flat-strip plastic lamellas, which has at one end a device according to the disclosure in accordance with the previous description; ii) attaching in each case one anchoring 11 in the marginal areas of the site of the bearing structure 12, which is to be reinforced, and applying the tension member 2 with the closing element to one of the anchorings 11; iii) applying a tensioning device to the end of the tension member 2 which has no closing element; iv) tensioning the tension member by the tensioning device and arranging the tension member 2 on the anchoring not yet occupied; v) applying at least one clamping element 3 made of plastic as described above to the non-anchored end of tensioned tension member, wherein the clamping element is arranged, relative to the tension direction of the tension member, immediately behind the anchoring; vi) sliding a sleeve 4, in the tension direction of the tension member, over the at least one clamping element 3, so that a clamping pressure is exerted on the tension member 2; and vii) making the tensioned tension member adhere to the bearing structure 12.

The tension member is made to adhere to the bearing structure by any method known to those skilled in the art. For example, it is possible to use for this purpose two-component adhesives based on epoxy resin as commercially available under the Sikadur® trade names from Sika Schweiz AG.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

1 Device for introducing a force
2 Tension member
21, 22 Tension member
3 Clamping element
3a Soft layer
3b Hard layer
4 Sleeve
4a External portion of the sleeve
4b Internal portion of the sleeve
41 Support
5 Slotted plate
6 Tension direction of the tension member
7 Friction element
8 Holding device
9 Tensioning device
10 Second slotted plate
11 Anchoring
11′ Anchor
12 Bearing structure
13 Tensioning element
14 Threaded rod
15 Screw nut
16 Anchoring
17 Chamfer (sleeve)
18 Chamfer (clamping element)
19 Sliding-on direction of the sleeve

What is claimed is:

1. A device for introducing a force into a tension member made of fiber-reinforced flat-strip plastic lamellas, the device comprising:
at least one clamping element configured for arrangement on a tension member and having at least one surface for contact with the tension member; and
at least one sleeve arranged around the clamping element, and configured to be arranged around the tension member, for exerting a clamping pressure on the tension member via the clamping element;
wherein
the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer; and
the clamping elements as a whole have a structure without wedge taper, or have a wedge-shaped or conical structure having a cross section reduction running against a tension direction of the tension member into which a force is to be introduced; and
the sleeve has an interior shape configured for receiving the at least one clamping element and for exerting a clamping pressure.

2. The device according to claim 1, wherein the material of the at least one soft layer has a bending tensile strength of ≧25 MPa and a compressive strength of ≧25 MPa.

3. The device according to claim 1, wherein a mean section height of the hard layer is greater than a mean section height of the soft layer.

4. The device according to claim 2, wherein a mean section height of the hard layer is greater than a mean section height of the soft layer.

5. The device according to claim 1, comprising:
two clamping elements configured for arrangement around the tension member, each having at least one surface for contact with the tension member, wherein the sleeve is arranged around the two clamping elements for exerting a clamping pressure on the tension member via the clamping elements.

6. The device according to claim 2, comprising:
two clamping elements configured for arrangement around the tension member, each having at least one surface for contact with the tension member, wherein the sleeve is arranged around the two clamping elements for exerting a clamping pressure on the tension member via the clamping elements.

7. The device according to claim 1, wherein the first soft layer is arranged to be between the tension member and the second hard layer, or the first soft layer is arranged between the second layer and the sleeve.

8. The device according to claim 2, wherein
the first soft layer arranged to be between the tension member and the second hard layer, or the first soft layer is arranged between the second layer and the sleeve.

9. The device according to claim 1, the clamping element comprising:
three layers, wherein one soft layer will adjoin the tension member, and one adjoins the sleeve, and a hard layer is arranged between the two soft layers.

10. The device according to claim 2, the clamping element comprising:
three layers, wherein one soft layer will adjoin the tension member, and one adjoins the sleeve, and a hard layer is arranged between the two soft layers.

11. The device according to claim 3, the clamping element comprising:
three layers, wherein one soft layer will adjoin the tension member, and one adjoins the sleeve, and a hard layer is arranged between the two soft layers.

12. The device according to claim 7, the clamping element comprising:
at least one soft layer for adjoining the tension member, wherein this soft layer has a wedge-shaped or conical structure with a cross section reduction selected to be against a tension direction of the tension member which is to receive a force.

13. The device according to claim 9, the clamping element comprising:
at least one soft layer for adjoining the tension member, wherein this soft layer has a wedge-shaped or conical structure with a cross section reduction selected to be against a tension direction of the tension member, which is to receive a force.

14. The device according to claim 1, wherein a contact surface between clamping element and tension member comprises:
a friction element.

15. The device according to claim 2, wherein a contact surface between clamping element and tension member comprises:
a friction element.

16. A tension member made of fiber-reinforced flat-strip plastic lamellas, including at least one device for introducing a force into a tension member, the device comprising:
at least one clamping element configured for arrangement on a tension member and having at least one surface for contact with the tension member; and
at least one sleeve arranged around the clamping element, and configured to be arranged around the tension member, for exerting a clamping pressure on the tension member via the clamping element;
wherein
the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer;
the clamping elements as a whole have a structure without wedge taper, or have a wedge-shaped or conical structure having a cross section reduction running against a tension direction of the tension member into which a force is to be introduced; and
the sleeve has an interior shape configured for receiving the at least one clamping element and for exerting a clamping pressure.

17. A method for introducing a force into a tension member made of fiber-reinforced flat-strip plastic lamellas, the method comprising:
i) arranging a device including at least one clamping element on the tension member with at least one surface in contact with the tension member; and thereafter sliding or pulling at least one sleeve around the clamping element and the tension member for exerting a clamping pressure on the tension member via the clamping element; wherein the clamping element is made of at least two layers arranged one on top of the other including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member, and the sleeve has an interior shape configured for receiving the at least one clamping element and for exerting a clamping pressure to the tension member;
ii) applying a tensioning device to the at least one clamping element with the sleeve, which is arranged on the tension member;
iii) introducing force into the tension member by the tensioning device.

18. A method for introducing a force into a tension member made of fiber-reinforced flat-strip plastic lamellas, the method comprising:
i) providing the tension member which is anchored with one end on a bearing structure;
ii) applying a tensioning device to a non-anchored end of the tension member;
iii) tensioning the tension member by the tensioning device;
iv) arranging a device including at least one clamping element on the tension member with at least one surface in contact with the tension member; and thereafter sliding or pulling at least one sleeve around the clamping element and the tension member for exerting a clamping pressure on the tension member via the clamping element; wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member, and the sleeve has an interior shape configured for receiving the at least one clamping element and for exerting a clamping pressure to the non-anchored end of the tension member, and
v) anchoring the non-anchored end of the tension member.

19. A method for reinforcing bearing structures, comprising:
i) providing a tension member made of fiber-reinforced flat-strip plastic lamellas, each member having a device including at least one clamping element arranged on the tension member and having at least one surface in contact with the tension member; and arranging at least one sleeve around the clamping element, and the tension member for exerting a clamping pressure on the tension member via the clamping element, wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member, and wherein the sleeve has an interior shape configured for receiving the at least one clamping element and for exerting a clamping pressure as closing elements;
ii) attaching a two-part tensioning device including anchoring and tensioning element in marginal areas of a site of a bearing structure which is to be reinforced;
iii) arranging the tension member on the surface of the bearing structure and introducing a closing element into a component of the tensioning device;
iv) tensioning the tension member; and
v) adhering the tensioned tension member to the bearing structure.

20. A method for reinforcing bearing structures, comprising:
i) providing a tension member made of fiber-reinforced flat-strip plastic lamellas, which has at one end a device for introducing a force into the tension member made of fiber-reinforced flat-strip plastic lamellas as a closing element;
ii) attaching in each case one anchoring in marginal areas of a site of the bearing structure, which is to be reinforced, and applying the tension member with the closing element to one of the anchorings;
iii) applying a tensioning device to an end of the tension member which has no closing element;
iv) tensioning the tension member by the tensioning device and arranging the tension member on the anchoring not yet occupied;
v) arranging a device to the non-anchored end of the tension member, the device including at least one clamping element on the tension member and having at least one surface in contact with the tension member, and sliding or pulling at least one sleeve around the clamping element and the tension member and for exerting a clamping pressure on the tension member via the clamping element, wherein the clamping element is made of at least two layers arranged one on top of the other and including at least one first soft layer made of a material having a modulus of elasticity ranging from 1000 to 6000 MPa, and at least one second hard layer made of a material having a higher modulus of elasticity than the at least one soft layer, and the clamping elements as a whole have a structure without wedge taper, or have a wedge-shaped or conical structure having a cross section reduction running against the tension direction of the tension member; and wherein the sleeve has an interior shape configured for receiving the at least one clamping element and for exerting a clamping pressure; and
vi) adhering the tensioned tension member adhere to the bearing structure.
